(19) United States
(12) Patent Application Publication
(10) Pub. No.: US 2026/0277910 A1
(43) Pub. Date: Sep. 17, 2026

(54) REAL-TIME RETRIEVAL OF SITE INFORMATION USING LARGE LANGUAGE MODEL (LLM)

(71) Applicant: Fluence Energy, LLC, Arlington, VA (US)

(72) Inventors: Sean McOsker, Fredericksburg, VA (US); Thomas J. Winter, Decatur, GA (US)

(73) Assignee: Fluence Energy, LLC, Arlington, VA (US)

(21) Appl. No.: 19/564,614

(22) Filed: Mar. 12, 2026

Related U.S. Application Data
(60) Provisional application No. 63/771,844, filed on Mar. 14, 2025.

(51) Int. Cl. G06F 16/2457; G06F 16/22; G06F 16/242

(52) U.S. Cl. CPC G06F 16/2457; G06F 16/2237; G06F 16/243

(57) ABSTRACT

A system and a method for providing fast information retrieval. The method includes receiving a user query from a user and operating data of an asset in a plant, analyzing the user query and the operating data to determine a state of the asset, generating a large language model (LLM) query to an LLM based on the user query and the t state, and interacting with an information acquisition agent (IAA) to obtain a response to the user query.

### CROSS-REFERENCE TO RELATED APPLICATIONS

The present application claims the benefit of priority to United States Provisional Application No. 63/771,844 filed on Mar. 14, 2025, which is hereby incorporated by reference in its entirety.

### TECHNICAL FIELD

The disclosure generally relates to large language model (LLM). More particularly, the subject matter disclosed herein relates to information retrieval using LLM.

### BACKGROUND

Highly specific and technical data has historically been difficult to acquire and ascertain. In general, the more specific a domain is, the more difficult to obtain operating data, configuration information, or technical jargon. This is largely due to the paucity of information itself in combination with domain experts decreasing as the domain becomes niche. One such domain is site operation, typically performed by skilled site service engineers with considerable training. Each service engineer has access to real-time site data, which they use to perform corrective maintenance and ensure site operation. However, in the case of less common fluctuations in site data, the service engineer may have to manually search company-specific operating manuals for a solution, a laborious and time-consuming process. This reduces the ability of the engineer to respond to issues in site operation with immediacy and can lead to potential downtime for the asset owner. For example, say a module at a site is low on coolant. To rectify this, the site engineer first recognizes the issue, then determines the requisite amount of coolant to add based on the site age, site configuration, and manufacturer before resolving the issue. This highly specific information retrieval (amount of coolant specific to a particular battery at a particular site by a particular manufacturer) tends to be time-consuming.

### SUMMARY

To overcome these issues, a system and a method for on-site information retrieval is disclosed. The technique provides fast information retrieval in response to a query. The method includes receiving a user query from a user and operating data of an asset in a plant, analyzing the user query and the operating data to determine a state of the asset, generating a large language model (LLM) query to an LLM based on the user query and the state, and interacting with an information acquisition agent (IAA) to obtain a response to the user query.

### BRIEF DESCRIPTION OF THE DRAWINGS

In the following section, the aspects of the subject matter disclosed herein will be described with reference to exemplary embodiments illustrated in the figures, in which:

FIG. 1 is a block diagram illustrating a system according to an embodiment.

FIG. 2A is a diagram illustrating a real-time information retrieval model according to an embodiment.

FIG. 2B is a diagram illustrating an information acquisition agent according to an embodiment.

FIG. 3 is a flowchart illustrating a process for real-time information retrieval according to an embodiment.

FIG. 4 is a flowchart illustrating a process of analyzing the operating data according to an embodiment.

FIG. 5 is a flowchart illustrating a process of generating an LLM query according to an embodiment.

FIG. 6 is a flowchart illustrating a process of interacting with an IAA according to an embodiment.

FIG. 7 is a flowchart illustrating a process of processing the LLM query according to an embodiment.

FIG. 8 is a flowchart illustrating a process of updating the vector database according to an embodiment.

FIG. 9 is a diagram illustrating a processing system according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments.

Also, depending on the context of discussion herein, a singular term may include the corresponding plural forms and a plural term may include the corresponding singular form. It is further noted that various figures(including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

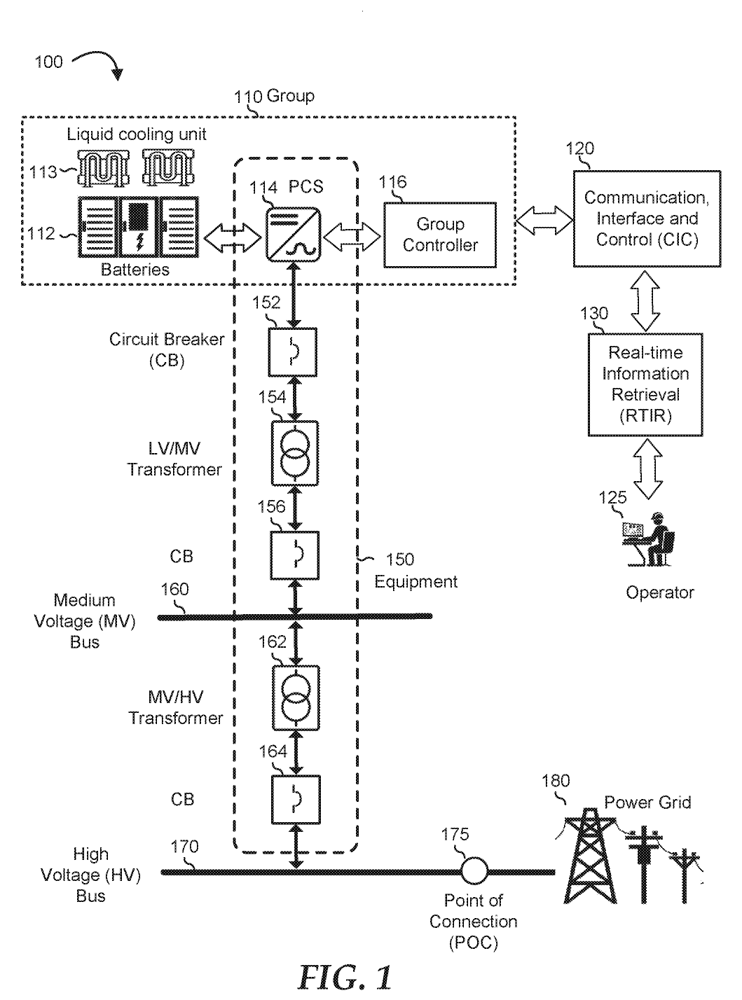

FIG. 1 is a block diagram illustrating a system 100 according to an embodiment. The system 100 depicts a Battery Energy Storage Systems (BESS). The system 100 may be referred to as a battery plant or a power plant. It includes a group 110, a communication, interface, and control (CIC) subsystem, agent or module 120, a real-time information retrieval (RTIR) module 130, a first circuit breaker (CB) 152, an LV/MV transformer 154, a second CB 156, an MV/HV transformer 162, a third CB 164, and a point of connection (POC) 175. The system 100 may include more than these components.

The group 110 represents components in a group of a multi-level hierarchical structure. The batteries in the BESS are often divided into groups for ease of management. For example, suppose the number of all batteries or battery modules in the BESS is N. These N batteries form an array of N batteries. The array may be divided in m groups, each having N/m batteries. Each of these may be referred to as a core. Each core may be further divided into smaller groups to form nodes. Each node may be formed by cubes and so on. For clarity and brevity, the term “group” refers to any of these levels. The group 110 includes a set of batteries 112, a cooling unit 113, a power conversion system (PCS) 114, and a group controller 116. The batteries 112 are rechargeable batteries. The types of batteries may include lithium-ion and lead-acid, but lithium-ion is the most popular type. The cooling unit 113 provides cooling to the batteries 112. The cooling may include any type of suitable cooling techniques such as liquid and air. In one embodiment, liquid cooling is employed. It typically includes tubes that carry liquid coolant through the racks that house the batteries 112. The PCS 114 converts the direct current (DC) to alternating current (AC) for use at the POC 175. When the batteries 112 need DC power, the PCS 114 may convers AC from an AC source to DC to the batteries. The group controller 116 performs control functions to elements in the group 110. In particular, it controls the liquid cooling unit 113 to trigger a cooling action.

The CIC 120 provides communication, interface, and control to various parts and components in the system 100. The communication uses communication protocols to allow exchange information among various components in the system 100. Examples of the protocols are Modbus TCP (Transmission Control Protocol), DNP3 (Distributed Network Protocol 3), and IEC (International Electrotechnical Commission) 104. The control may include data acquisition, sensing operations, and monitoring. Examples include SCADA (Supervisory Control and Data Acquisition systems which use networks, computers, and human-machine interfaces (HMIs) to gather and analyze data in real time. The CIC 120 also provides interfaces to various components and devices in the system 110, including a user interface to an operator or a user 125. The operator or user 125 may be any individual who interacts with the components in the system 100. In one embodiment, the operator or user 125 is a service engineer or technician who consults the RTIR 130 to obtain real-time information on an asset or a component that may be under service. By using the RTIR 130, the operator or user 125 quickly obtains information on the asset or the procedure of serving the asset.

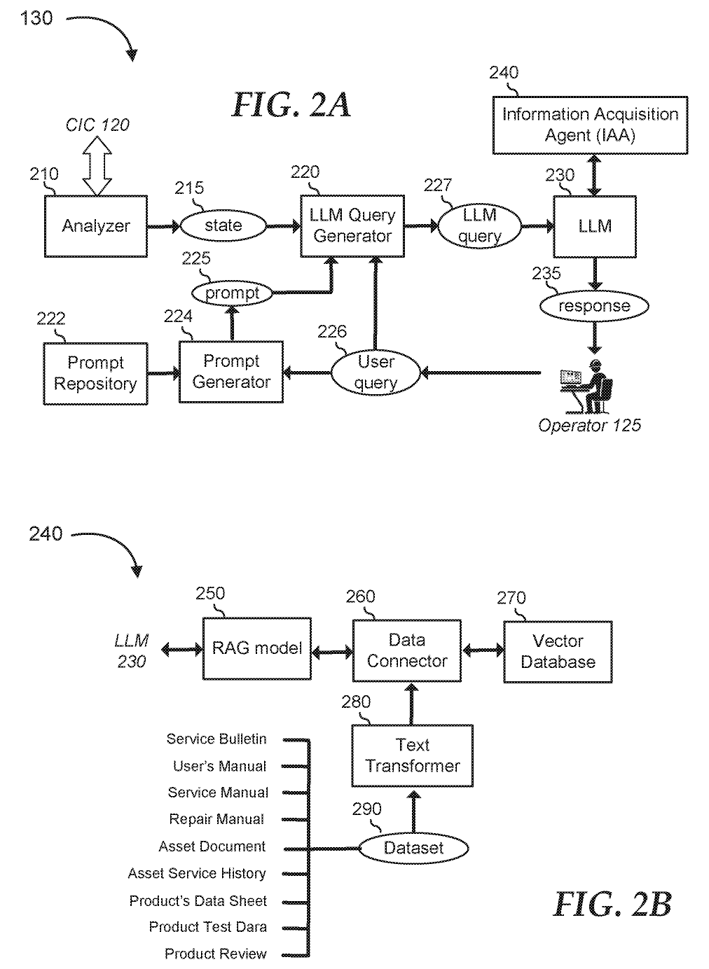

The RTIR module 130 is configured to provide information retrieval on a real-time basis on site. The RTIR 130 will be described further in FIG. 2. The first CB 152 acts to connect the PCS 114 to other equipment and to isolate the PCS 114 from the other equipment. The LV/MV transformer 154 steps up a low voltage (LV) at the LV side at the first CB 152 to a medium voltage (MV) at the MV side at the second CB 156. It may also step down the MV at the second CB 156 to a LV at the first CB 152. The second CB 156 connects the LV/MV transformer 154 to an MV bus 160. The MV/HV transformer 162 steps up the MV at the MV side at the MV bus 160 to a high voltage (HV) at the HV side at the third CB 164. When it is used in a bidirectional mode, the MV/HV transformer 162 may also step down the HV at the third CB 164 to the MV at the MV bus 160. The POC 175 is the point of connection to a power grid 180. It may also be the connection point from another energy source.

The PCS 114, the first CB 152, the LV/MV transformer 154, the second CB 156, the MV/HV transformer 162 and the CB 164 form equipment 150. The equipment 150 have internal losses along the way from the batteries 112 to the POC 175. Because of these losses, the output power of the batteries 112 is reduced at the POC 175.

FIG. 2A is a diagram illustrating the RTIR 130 shown in FIG. 1 according to an embodiment. The RTIR 130 includes an analyzer 210, and LLM query generator 220, a prompt repository 222, a prompt generator 224, a large language model (LLM) 230, and an information acquisition agent (IAA) 240. The RTIR 130 may include more or less than the above components.

The analyzer 210 is configured to receive operating data of an asset in the plant similar to the system 100 in FIG. 1 and analyze the operating data from the CIC 120 to determine a state 215 of the asset. The operating data may include normal or anomalous data that reflect the current or operational state of the asset of the plant. The analyzer 210 perform the analysis of the operating data by querying an operating system (OS) of the asset, interacting with an asset performance analyzer to obtain analysis results, and interacting with at least one of a controller, a monitor, a sensor, a data acquisition unit, a communication interface. The state 215 includes at least one of a maintenance state, an installation state, a repair state, a failure state, and a service state. The analyzer 210 forwards the state 215 to the LLM query generator 220.

The LLM query generator 220 is configured to receive at least three inputs: the state 215 from the analyzer 210, a user query 226 from the operator or user 125, and a prompt 225 from the prompt generator 224. The user query 226 may be a query about an asset or an equipment that may be under service in the plant. It may also be an inquiry about the cause of an anomalous condition of an asset. The LLM query generator 220 is configured to generate an LLM query 227 to the LLM 230 based on the received state 215, the user query 226, and the prompt 225. The prompt generator 224 generates the prompt 225 based on the user query 226 and a prompt repository 222. The prompt 225 is specifically crafted to guide the behavior of the LLM 230. It may be a text that supplements the user query 226 or an instruction to tell what the LLM 230 should do or include in its response. The prompt 225 may be a shot-based prompt, where “shot” refers to the number of examples included in the prompt. For example, a zero-shot prompt gives a direct instruction without any examples and a one-shot prompt provides a single example. The prompt generator 224 may modify the user query 226 to focus more on the particular environment, the operating data, or the state of the plant. It may rely on guidance on criteria or previous prompts stored in the prompt repository 222. For example, the user query 226 may ask, “How much coolant to be used at the battery site XYZ?” The prompt generator 224 may retrieve a previous query or prompt from the prompt repository 222 related to the query and add further details about the type of coolant and the average amount at the battery site XYZ. This will help refine, and add context to, the query. The prompt repository 222 may be initially populated with specific information on the asset and the plant. It may then be updated as new queries and responses are generated. By re-using previous prompts for a particular type of user query, the prompt generator 224 can provides accurate guidance. The LLM query generator 220 further refines the user query 226 using the prompt 225 and the state 215.

The LLM 230 is configured to provide a response 235 to the user query 226. The response 235 is forwarded to the operator or user 125. In one embodiment, the LLM 230 is a pre-trained LLM which has been exposed to a broad and general dataset. In other embodiments, the LLM 230 may be trained with a small and specific dataset which complements the dataset used in the IAA 240 (described later). The LLM 230 is configured to search for information related to the user query 226 such as a service procedure operated on the asset. The LLM 230 performs the search by interacting with the IAA 240 to obtain a response 235 to the user query 226. The LLM 230 forwards the LLM query 227 to the IAA 240. The IAA 240 is configured to provide information related to the search requested by the LLM 230 based on the LLM query 227. The IAA will be described in FIG. 2B. The LLM 230 receives the search result from the IAA 240 and forms the response 235 to be forwarded back to the operator or user 125.

FIG. 2B is a diagram illustrating the IAA 240 shown in FIG. 2A according to an embodiment. The IAA 240 includes a retrieval-augmented generation (RAG) model 250, a data connector 260, a vector database 270, and a text transformer 280. The IAA 240 may include more or less than the above components. In addition, any one of the above components may be split into two or more components or merged with one or more other components. For example, the data connector 260 may be integrated with the RAG model 250 which in turn may be combined with the LLM 230 in FIG. 2A. The main function of the IAA 240 is to obtain search results for the queries and generate more accurate and contextually relevant responses for the search results.

The RAG model 250 is configured to process the LLM query 227 forwarded by the LLM 230 to generate a search query to search the vector database 270. It may parse the LLM query 227 into linguistic or semantic elements to understand the nature of the query or the type of requested information. It may break the LLM query 227 into separate sub-queries to search for specific pieces of information. It then passes the parsed queries to the data connector 260. The data connector 260 is configured to act as a bridge between the RAG model 250 and the vector database 270. The bridge is bidirectional. In one direction, the data connector 260 forwards the search query from the RAG model 250 to the vector database 270. In the opposite direction, the data connector 260 receives a search result from the vector database 270 and forwards it to the RAG model 250 which will forward it to the LLM 230. The data connector 260 may also be used to connect the text transformer 280 to the vector database 270.

The text transformer 280 transforms or converts texts from a dataset 290 to vector components to be stored in the vector database. The vector components follow a predefined format in the vector database 270 for storage and retrieval. The text transformer 280 generates text embeddings using phrase or sentence transformers to express words or phrases numerically within a high-dimensional vector space. It may tokenize the texts into chunks of text and transform the text chunks into vector components. The dataset 290 includes a library of files or documents that contain information relevant to the user query 226. The information may be about the various components of the plant shown in FIG. 1 such as transformers, cooling units, circuit breakers, battery systems, busbars, reactors, and switchboards. These files or documents may exist in any suitable format including standardized file formats. In one embodiment, the dataset 290 includes at least one data file having a type of one of a service bulletin, a user’s manual, a service manual, a repair manual, an asset document, an asset service history, a product datasheet, a product test data, and a product review.

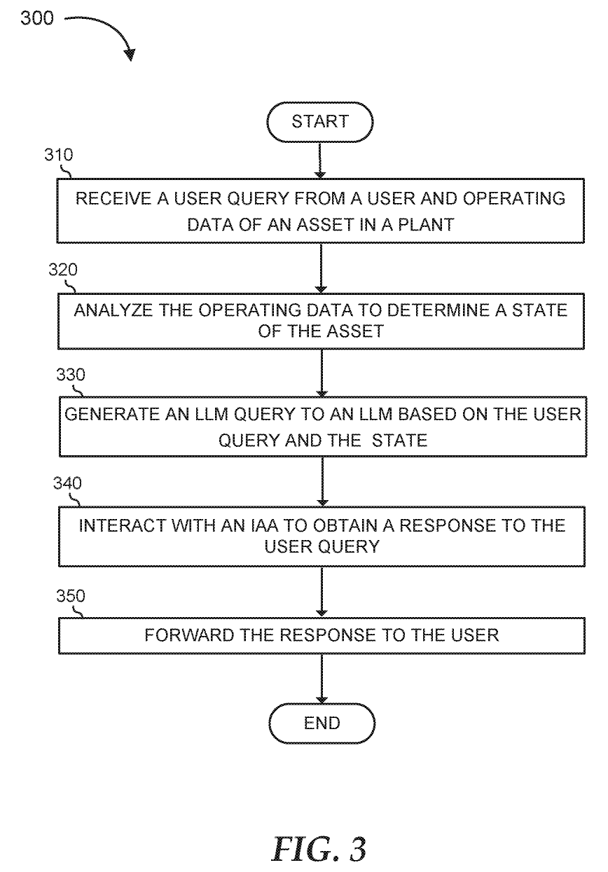

FIG. 3 is a flowchart illustrating a process 300 for real-time information retrieval according to an embodiment.

Upon START, the process 300 receives a user query from a user and operating data of an asset in a plant (Block 310). The operating data are related to the working conditions of the asset in the plant, including whether the asset is operating normally or with anomaly. Next, the process 300 analyzes operating data to determine a state of the asset (Block 320). The state of the asset is related to the user query. In one embodiment, the state of the asset includes at least one of a maintenance state, an installation state, a repair state, a failure state, and a service state. Next, the process 300 generates an LLM query to an LLM based on the user query and the state (Block 330). The LLM may be a pre-trained LLM. Then, the process 300 interacts with an information acquisition agent (IAA) to obtain a response to the user query (Block 340). The IAA has information that is relevant to the user query. The IAA performs a search for information responsive to the query. Next, the process 300 forwards the response to the user (Block 350). The process 300 is then terminated.

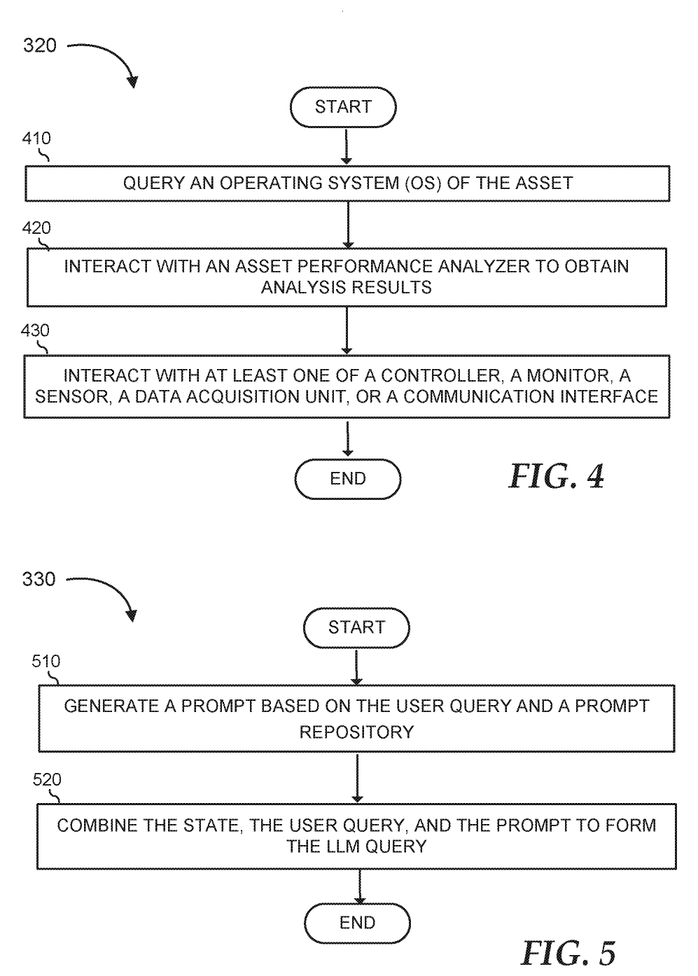

FIG. 4 is a flowchart illustrating the process 320 of analyzing the operating data shown in FIG. 3 according to an embodiment.

Upon START, the process 320 queries an operating system (OS) of the asset (Block 410). Typically, the OS of the asset includes an application that monitors the asset to have real-time information on the status of various components in the asset. Next, the process 320 interacts with an asset performance analyzer to obtain analysis results (Block 420). The asset performance analysis analyzes data obtained from real-time monitoring, automated reporting, and data analytics across power and storage assets.

Then, the process 320 interacts with at least one of a controller, a monitor, a sensor, a data acquisition unit, or a communication interface (Block 430).. These elements are typically included in a communication, interface, and control functionality or agent located in the plant. The process 320 is then terminated.

FIG. 5 is a flowchart illustrating the process 330 of generating an LLM query shown in FIG. 3 according to an embodiment.

Upon START, the process 330 generates a prompt based on the user query and a prompt repository (Block 510). The prompt may be a text supplementing the query or an instruction to instruct the LLM to perform a task. Next, the process 330 combines, merges, or integrates the state, the user query, and the prompt to form the LLM query (Block 520). The LLM query will be transformed to a search query to a vector database to search for information. The process 330 is then terminated.

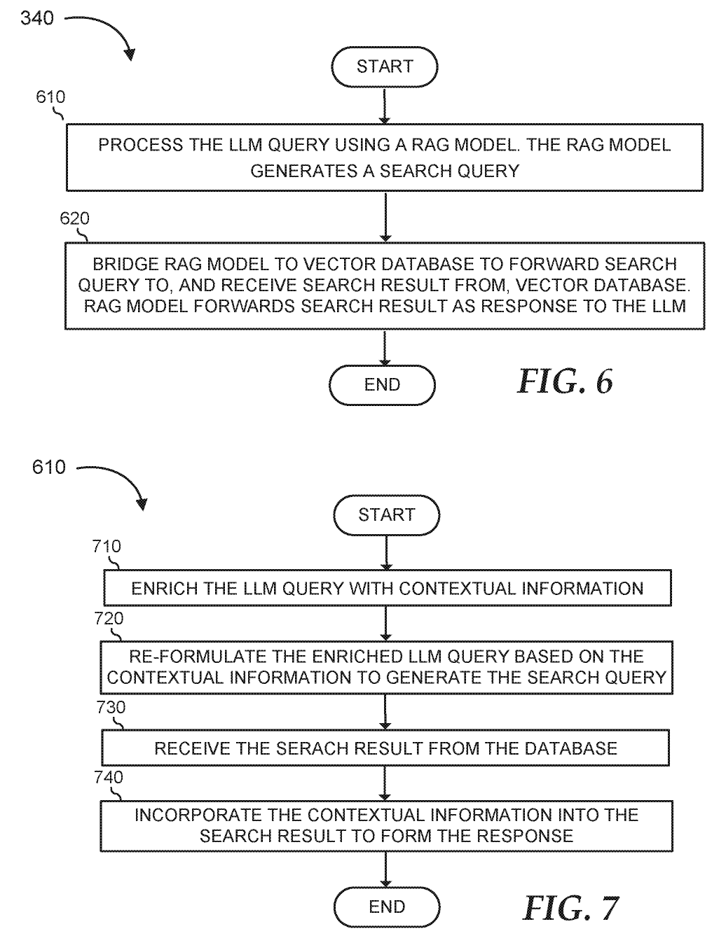

FIG. 6 is a flowchart illustrating a process 340 of interacting with an IAA shown in FIG. 3 according to an embodiment.

Upon START, the process 340 processes the LLM query using a retrieval-augmented generation (RAG) model (Block 610). The RAG model is configured to generate a search query to a vector database. Next, the process 340 bridges the RAG model to a vector database to forward the search query to, and receive a search result from, the vector database (Block 620). The RAG model forwards the search result as the response to the LLM. The process 340 is then terminated.

FIG. 7 is a flowchart illustrating a process 610 of processing the LLM query shown in FIG. 6 according to an embodiment.

Upon START, the process 610 enriches the LLM query with contextual information (Block 710). The contextual information may be related to aspects not explicitly expressed in the LLM query. Next, the process 610 re-formulates the enriched LLM query based on the contextual information to generate the search query (Block 720). The search query follows the format employed by the vector database. In response to the search query, the vector database generates a search result. Next, the process 610 receives the search result from the vector database (Block 730). Then, the process 610 incorporates the contextual information into the search result to form the response that will be forwarded to the LLM (Block 740). The process 610 is then terminated.

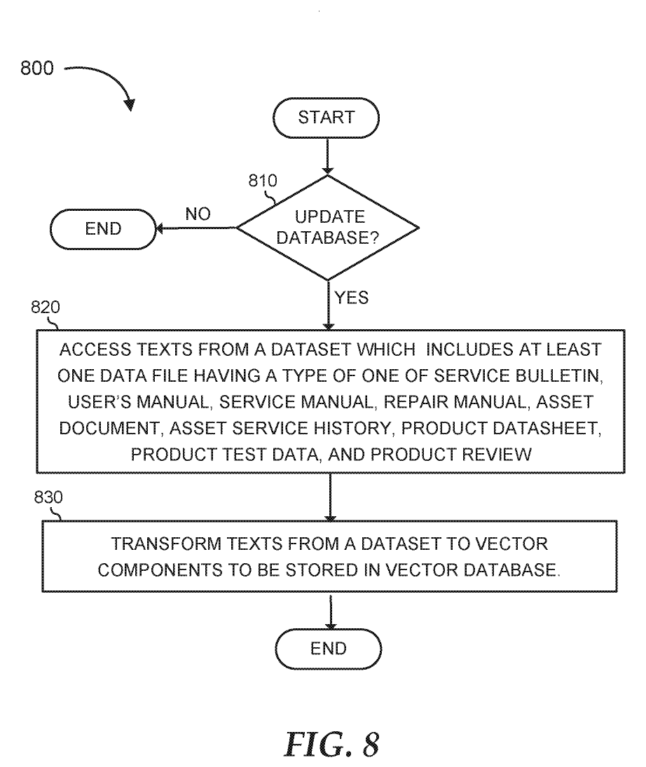

FIG. 8 is a flowchart illustrating a process 800 of updating the vector database according to an embodiment. The process 800 may be performed whenever the vector database needs to be updated. This may occur at the beginning when the database is first established or whenever new information is available. The update mainly includes adding information to the vector database. It may also include removing old or obsolete information from the vector database.

Upon START, the process 800 determines if the database needs to be updated (Block 810). If NO, the process 800 is terminated. Otherwise, the process 800 accesses texts from a dataset which includes at least one data file having a type of one of a service bulletin, a user’s manual, a service manual, a repair manual, an asset document, an asset service history, a product datasheet, a product test data, and a product review (Block 820). In one embodiment, the dataset may include service or test reports from the field technicians or the operator 125 or other service personnel. Next, the process 800 transforms texts from a dataset to vector components to be stored in the vector database (Block 830). The process 800 is then terminated.

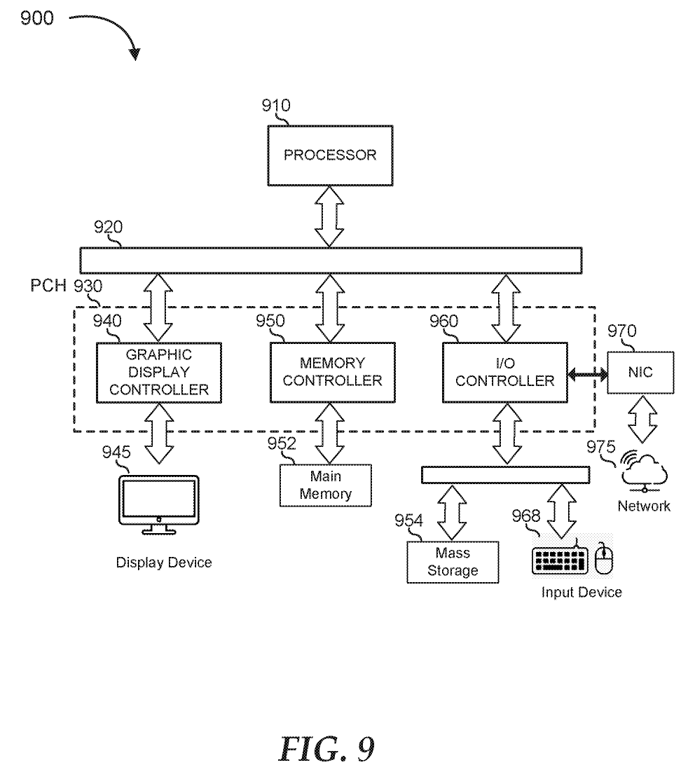

FIG. 9 is a diagram illustrating a processing or computing system 900 according to an embodiment.

The processing system or computing system 900 may be a host in a system on which the RTIR 130 operates. It includes a central processing unit (CPU) or a processor 910, a platform controller hub (PCH) 930, and a bus 920. The PCH 930 may include a graphic display controller (GDC) 940, a memory controller 950, and an input/output (I/O) controller 960. The processing system 900 may include more or less than the above components. In addition, a component may be integrated into another component. As shown in FIG. 9, all the controllers 940, 950, and 960 are integrated in the PCH 930. The integration may be partial and/or overlapped. For example, the GDC 940 may be integrated into the processor 10, the I/O controller 960 and the memory controller 950 may be integrated into one single controller, etc.

The processor 910 is a programmable device that may execute a program or a collection of instructions to carry out a task. It may be a general-purpose processor, a digital signal processor, a microcontroller, or a specially designed processor such as one design from Applications Specific Integrated Circuit (ASIC). It may include a single core or multiple cores. Each core may have multi-way multi-threading. The processor 910 may have simultaneous multithreading feature to further exploit the parallelism due to multiple threads across the multiple cores. In addition, the processor 910 may have internal caches at multiple levels.

The bus 920 may be any suitable bus connecting the processor 910 to other devices, including the PCH 930. For example, the bus 920 may be a Direct Media Interface (DMI).

The PCH 930 in a highly integrated chipset that includes many functionalities to provide interface to several devices such as memory devices, input/output devices, storage devices, network devices, etc.

The I/O controller 960 controls input devices 968 (e.g., stylus, keyboard, and mouse, microphone, image sensor) and output devices (e.g., audio devices, speaker, scanner, printer), and a mass storage 954. The mass storage 954 may also include CD-ROM, hard disk, and solid-state drives (SSDs). It also has a network interface card (NIC) 970 which provides interface to a network and wireless medium 975.

The memory controller 950 controls memory devices such as a main memory 952. The main memory 952 includes random access memory (RAM) and/or the read-only memory (ROM) and other types of memory such as the cache memory or an SSD. The main memory 952 may store instructions or programs, loaded from a mass storage device, that, when executed by the processor 910, cause the processor 910 to perform operations as described above. It may also store data used in the operations. The ROM may include instructions, programs, constants, or data that are maintained whether it is powered or not. The instructions or programs may correspond to the functionalities described above, such as the RTIR 130 or the IAA 240.

The GDC 940 controls a display device 945 and provides graphical operations. It may be integrated inside the processor 910. It typically has a graphical user interface (GUI) to allow interactions with a user who may send a command or activate a function.

Additional devices or bus interfaces may be available for interconnections and/or expansion. The bus interfaces may be serial or parallel, with or without power delivery, etc.

The technique described in this disclosure has several advantages compared to existing techniques. First, it allows quick access to information on an asset or equipment. When the asset is being serviced, this quick access reduces downtime and improves performance. Second, the provided information is highly reliable because it is fine-tuned to the specific subject area related to the asset. Third, the information is versatile because the RTIR has access to several devices or instruments that monitor the asset on a real-time and regular basis.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. An apparatus comprising:
a processor; and
a memory containing instructions that, when executed by the processor, cause the processor to perform operations comprising:
receiving a user query from a user and operating data of an asset in a plant;
analyzing the operating data to determine a state of the asset; and
generating a large language model (LLM) query to an LLM based on the user query and the state; and
interacting with an information acquisition agent (IAA) to obtain a response to the user query.

2. The apparatus of claim 1, wherein interacting with the IAA comprises:
processing the LLM query using a retrieval-augmented generation (RAG) model, the RAG model generating a search query; and
bridging the RAG model to a vector database to forward the search query to, and receive a search result from, the vector database,
wherein the RAG model forwards the search result as the response to the LLM.

3. The apparatus of claim 2, wherein the operations further comprise:
transforming texts from a dataset to vector components to be stored in the vector database,
wherein the dataset includes at least one data file having a type of one of a service bulletin, a user’s manual, a service manual, a repair manual, an asset document, an asset service history, a product datasheet, a product test data, and a product review.

4. The apparatus of claim 2, wherein processing the LLM query comprises at least one of:
enriching the LLM query with contextual information;
re-formulating the enriched LLM query based on the contextual information to generate the search query; and
incorporating the contextual information into the search result to form the response.

5. The apparatus of claim 1, wherein analyzing the operating data comprises:
querying an operating system (OS) of the asset;
interacting with an asset performance analyzer to obtain analysis results; and
interacting with at least one of a controller, a monitor, a sensor, a data acquisition unit, or a communication interface.

6. The apparatus of claim 1, wherein generating the LLM query comprises:
generating a prompt based on the user query and a prompt repository; and
combining the state, the user query, and the prompt to form the LLM query.

7. The apparatus of claim 6, wherein the prompt is a shot-based prompt.

8. The apparatus of claim 1, wherein the operations further comprise:
forwarding the response to the user.

9. The apparatus of claim 1, wherein the state of the asset includes at least one of a maintenance state, an installation state, a repair state, a failure state, and a service state.

10. The apparatus of claim 1, wherein the asset is an equipment in a battery energy storage system (BESS).

11. A method comprising:
receiving a user query from a user and operating data of an asset in a plant;
analyzing the operating data to determine a state of the asset;
generating a large language model (LLM) query to an LLM based on the user query and the state; and
interacting with an information acquisition agent (IAA) to obtain a response to the user query.

12. The method of claim 11, wherein interacting with the IAA comprises:
processing the LLM query using a retrieval-augmented generation (RAG) model, the RAG model generating a search query; and
bridging the RAG model to a vector database to forward the search query to, and receive a search result from, the vector database,
wherein the RAG model forwards the search result as the response to the LLM.

13. The method of claim 12 further comprising:
transforming texts from a dataset to vector components to be stored in the vector database,
wherein the dataset includes at least one data file having a type of one of a service bulletin, a user’s manual, a service manual, a repair manual, an asset document, an asset service history, a product datasheet, a product test data, and a product review.

14. The method of claim 12, wherein processing the LLM query comprises at least one of:
enriching the LLM query with contextual information;
re-formulating the enriched LLM query based on the contextual information to generate the search query; and
incorporating the contextual information into the search result to form the response.

15. The method of claim 11, wherein analyzing the operating data comprises:
querying an operating system (OS) of the asset;
interacting with an asset performance analyzer to obtain analysis results, and
interacting with at least one of a controller, a monitor, a sensor, a data acquisition unit, a communication interface.

16. The method of claim 11, wherein generating an LLM query comprises:
generating a prompt based on the user query and a prompt repository; and
combining the state, the user query, and the prompt to form the LLM query.

17. The method of claim 16, wherein the prompt is a shot-based prompt.

18. The method of claim 11 further comprising:
forwarding the response to the user.

19. The method of claim 11, wherein the current state of the asset includes at least one of a maintenance state, an installation state, a repair state, a failure state, and a service state.

20. A battery energy storage system (BESS) comprising:
an asset in a plant;
a communication, interface, and control (CIC) agent; and
a real-time information retrieval comprising:
an analyzer configured to receive operating data of the asset in the plant from the CIC agent and analyze a user query and the operating data to determine a state of the asset,
a large language model (LLM) query generator configured to generate an LLM query to an LLM based on the user query and the state, and
an LLM configured to interact with an information acquisition agent (IAA) to obtain a response to the user query.
